(19) United States
(12) Patent Application Publication
(10) Pub. No.: US 2026/0368936 A1
(43) Pub. Date: Nov. 19, 2026

(54) OFFSET LOW DISCREPANCY SPHERICAL SAMPLING FOR IMAGE RENDERING

(71) Applicant: DOLBY LABORATORIES LICENSING CORPORATION, San Francisco, CA (US)

(72) Inventor: William Anthony Rozzi, Califon, NJ (US)

(73) Assignee: DOLBY LABORATORIES LICENSING CORPORATION, (US)

(21) Appl. No.: 19/136,499

(22) PCT Filed: Dec. 6, 2023
(86) PCT No.: PCT/US2023/082743

§ 371 Date: Jun. 6, 2025

Related U.S. Application Data
(60) Provisional application No. 63/386,559, filed on Dec. 8, 2022.

(30) Foreign Application Priority Data
Apr. 4, 2023 (EP) 23166550.6

(51) Int. Cl. G06T 9/00; G06F 3/01

(52) U.S. Cl. CPC G06T 9/00; G06F 3/013

(57) ABSTRACT

Systems and methods for 360° image rendering. One example image processing system includes a processor to perform encoding of data, the processor configured to receive a three-dimensional environment. The processor is configured to apply, for a set of cube map texture coordinates, a cube map function to the cube map texture coordinates to generate a cube map direction, apply a low discrepancy sequence sampling function to the cube map direction to generate a low discrepancy spherical sampling direction, and apply an offset cube mapping function to the low discrepancy spherical sampling direction to generate an offset sampling direction. The processor is configured to generate a pixel value for the cube map texture coordinates using the offset sampling direction and the three-dimensional environment.

### 1. CROSS-REFERENCE TO RELATED APPLICATIONS

This application claims priority of the following priority applications; U.S. provisional application 63/386,559 (reference: D22061USP1), filed on 8 Dec. 2022, and European Application No. 23166550.6 (reference: D22061EP), filed on 4 Apr. 2023, each of which is hereby incorporated in its entirety.

### 2. FIELD OF THE DISCLOSURE

Various example embodiments relate to image-processing operations and, more specifically but not exclusively, to 360° image rendering.

### 3. BACKGROUND

Human visual acuity has a peak in the fovea where cone concentration is highest, and falls off with increasing retinal eccentricity. Foveated rendering refers to a collection of computer graphics techniques in which the resolution of a rendered image is tailored to match the visual acuity of the eyes of the viewer. That is, more detail is provided at the center of the viewer's gaze, and progressively less detail is provided further from that point. This technique is implemented in virtual reality (VR) and augmented reality (AR) applications, as foveated rendering provides reductions in rendering time and data transmission bandwidth.

Cube map texturing is a technique for representing a three-dimensional (3D) environment map such as a 360° still image or video frame. Particularly, a textured 3D cube is represented as six two-dimensional (2D) textures, one for each cube face. Modern graphics processing units (GPUs) offer hardware support for cube map texturing, including handling sampling across more than a single cube face.

### BRIEF SUMMARY OF SOME SPECIFIC EMBODIMENTS

Disclosed herein are various embodiments of image processing systems for encoding and decoding spherically-sampled data. One example embodiment provides an image processing system comprising a processor to perform encoding of data, the processor configured to receive a three-dimensional environment. The processor is configured to apply, for a set of cube map texture coordinates, a cube map function to the cube map texture coordinates to generate a cube map direction, apply a low discrepancy sequence sampling function to the cube map direction to generate a low discrepancy spherical sampling direction, and apply an offset cube mapping function to the low discrepancy spherical sampling direction to generate an offset sampling direction. The processor is configured to generate a pixel value for the cube map texture coordinates using the offset sampling direction and the three-dimensional environment.

According to an example embodiment, provided is an image processing system for encoding spherically-sampled data. The image processing system comprises a processor to perform encoding of data. The processor is configured to receive a three-dimensional environment, apply, to a set of cube map texture coordinates, an offset low discrepancy sequence (OLDS) sampling function to generate an OLDS direction, and generate a pixel value for the cube map texture coordinates using the OLDS direction and the three-dimensional environment.

According to another example embodiment, provided is an image processing system for decoding spherically-sampled data. The image processing system comprises a processor to perform decoding of data, the processor configured to receive, from a coded bitstream, an offset sampled cube map. The processor is configured to apply, for an offset sampling direction, an inverse offset cube mapping function to the offset sampling direction to generate a low discrepancy spherical sampling direction, apply an inverse low discrepancy sequence sampling function to the low discrepancy spherical sampling direction to generate a cube map direction, and apply an inverse cube map function to the cube map direction to generate cube map texture coordinates. The processor is configured to generate a pixel value for the offset sampling direction using the cube map texture coordinates and the offset sampled cube map.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 depicts an example process for a video delivery pipeline according to one embodiment.

FIG. 2 depicts an example representation of a vision field of an average viewer's eye.

FIG. 3 depicts an example cube map within a 3D environment according to one embodiment.

FIGS. 4A-4C depict an example offset cube map within a 3D environment according to one embodiment.

FIGS. 5A-5C depict various example sampling density uniformity of a cube map.

FIGS. 6A-6C depict various example sampling density uniformity of an offset cube map.

FIG. 7 depicts triangle areas from Delaunay triangulation of an offset standard cube map spherical sampling.

FIG. 8 depicts triangle area from Delaunay triangulation of an offset unicube cube map spherical sampling.

FIG. 9 depicts an example process performed by the video delivery pipeline of FIG. 1 according to one embodiment.

FIG. 10 depicts another example process performed by the video delivery pipeline of FIG. 1 according to one embodiment.

### DETAILED DESCRIPTION

This disclosure and aspects thereof can be embodied in various forms, including hardware, devices or circuits controlled by computer-implemented methods, computer program products, computer systems and networks, user interfaces, and application programming interfaces; as well as hardware-implemented methods, signal processing circuits, memory arrays, application specific integrated circuits (ASICs), field programmable gate arrays (FPGAs), and the like. The foregoing is intended solely to give a general idea of various aspects of the present disclosure, and does not limit the scope of the disclosure in any way.

A video application as described herein may refer to any of: video display applications, VR applications, AR applications, automobile entertainment applications, remote presence applications, display applications, gaming applications, mobile applications, internet-based video streaming applications, and the like.

The techniques can be applied to virtual reality cinema-immersive movie watching (e.g., for headmounted displays, etc.) for streaming video data between video streaming server(s) and video streaming client(s). Example video content may include, but are not necessarily limited to, any of: audiovisual programs, movies, video programs, TV broadcasts, computer games, AR content, VR content, automobile entertainment content, and the like. Example video streaming clients may include, but are not necessarily limited to, any of: display devices, a computing device with a near-eye display, a head-mounted display (HMD), a mobile device, a wearable display device, a set-top box with a display such as television, a video monitor, and the like.

As used herein, a “video streaming server” may refer to one or more upstream devices that prepare and stream video content to one or more video streaming clients in order to render at least a portion (e.g., corresponding to a user's FOV or viewport, etc.) of the video content on one or more (target) displays. The displays on which the video content is rendered may be part of the one or more video streaming clients or may be operating in conjunction with the one or more video streaming clients. Example video streaming servers may include, but are not necessarily limited to, any of: cloud-based video streaming servers located remotely from video streaming client(s), local video streaming servers connected with video streaming client(s) over local wired or wireless networks, VR devices, AR devices, automobile entertainment devices, digital media devices, digital media receivers, set-top boxes, gaming machines, general purpose personal computers, tablets, dedicated digital media receivers, and the like.

### Video Coding According to Example Embodiments

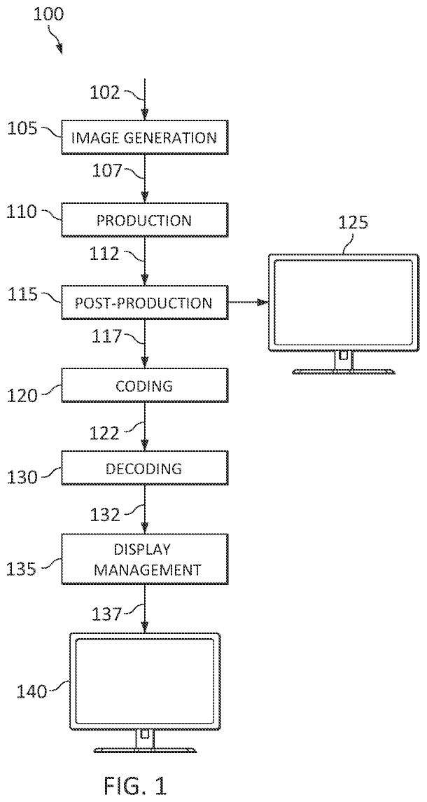

FIG. 1 depicts an example process of a video delivery pipeline 100, showing various stages from video capture to video-content display according to an embodiment. A sequence of video frames 102 may be captured or generated using an image-generation block 105. The video frames 102 may be digitally captured (e.g., by a digital camera) or generated by a computer (e.g., using computer animation) to provide video data 107. Alternatively, the video frames 102 may be captured on film by a film camera. Then, the film may be translated into a digital format to provide the video data 107.

In a production phase 110, the video data 107 may be edited to provide a video production stream 112. The data of the video production stream 112 may then be provided to a processor (or one or more processors, such as a central processing unit, CPU) at a post-production block 115 for post-production editing. The post-production editing of the block 115 may include, e.g., adjusting or modifying colors or brightness in particular areas of an image to enhance the image quality or achieve a particular appearance for the image in accordance with the video creator's creative intent. This part of post-production editing is sometimes referred to as “color timing” or “color grading.” Other editing (e.g., scene selection and sequencing, image cropping, addition of computer-generated visual special effects, etc.) may be performed at the block 115 to yield a “final” version 117 of the production for distribution. For example, rendering techniques described herein, such as cube mapping techniques, cube map offset techniques, and sampling techniques may be performed during post-production editing 115. During the post-production editing 115, video images may be viewed on a reference display 125. In other instances, the rendering techniques described herein may be performed at image generation block 105, production phase 110, or another suitable processing step within the video delivery pipeline 100.

Following the post-production 115, video data of the final version 117 may be delivered to a coding block 120 for being delivered downstream to decoding and playback devices, such as VR headsets, near-eye displays, and the like. In some embodiments, the coding block 120 may include audio and video encoders, such as those defined by the ATSC, DVB, DVD, Blu-Ray, and other delivery formats, to generate a coded bitstream 122. In a receiver, the coded bitstream 122 is decoded by a decoding unit 130 to generate a corresponding decoded signal 132 representing a copy or a close approximation of the signal 117. The receiver may be attached to a target display 140 that may have somewhat or completely different characteristics than the reference display 125. In such cases, a display management (DM) block 135 may be used to map the decoded signal 132 to the characteristics of the target display 140 by generating a display-mapped signal 137. Depending on the embodiment, the decoding unit 130 and display management block 135 may include individual processors or may be based on a single integrated processing unit. The coded bitstream 122 may include metadata to assist in the reconstruction of the final version 117.

### Human Vision Field

Techniques as described herein may be implemented based on the knowledge of the (human) eye and how the eye perceives luminance, colors, spatial resolution, and the like. These techniques may be applied based on the individual viewer's specific vision characteristics or a user population's average or collective vision characteristics.

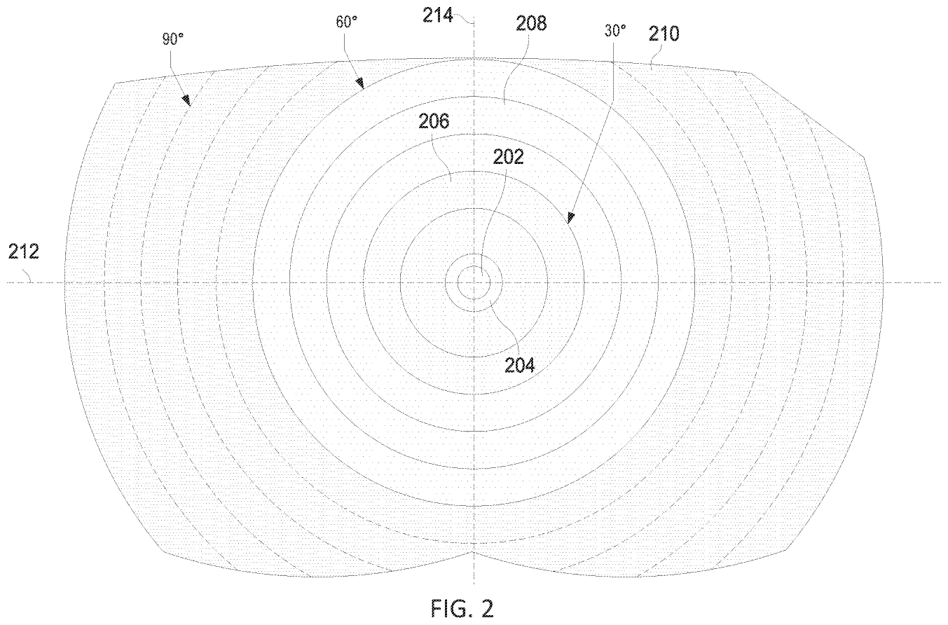

FIG. 2 illustrates an example representation of a vision field of an average viewer's eye. Cone and rod distributions (in the eye) can be segmented into different distribution ranges of cones and rods and further projected into an angular vision field representation (of the eye) as illustrated in FIG. 2. Highest levels of visual perception are achieved in the eye's foveal (vision field) region 202.

By way of example but not limitation, the widest angular range in the eye's vision field is along the horizontal direction of FIG. 2, which is parallel to the inter-pupil line between the viewer's two eyes, without considering visual constraints from facial anatomy, and may be approximately 180 angular degrees.

Each of concentric circles (e.g., labelled as 30°, 60°, 90°, etc.) represents directions of equal (or the same) angular degree relative to a view direction of the viewer's left or right eye. It should be noted that angles such as 30°, 60°, 90°, etc., are for illustration purposes only. Different values of angles or different sets of angles can be used to define or describe a viewer's vision field. The view direction (not shown in FIG. 2) is pointed vertically out of the plane of FIG. 2 at the intersection of a transverse direction 212 and a vertical direction 214 in a foveal region 202 (the darkest fill pattern). Here, the transverse direction 212 and the vertical direction 214 form a plane normal to the view direction.

As illustrated in FIG. 2, the vision field of the eye may be partitioned (e.g., logically, projected by certain partitions in the distributions of densities of rods/cones, etc.) into the foveal region 202 immediately surrounded by a paracentral region 204. In some embodiments, the foveal region 202 may correspond to the viewer's fovea vision and extend from zero (0) angular degrees to a first angle (e.g., 2-4 angular degrees, 3-7 angular degrees, 5-9 angular degrees, etc.) relative to the view direction. In some embodiments, the paracentral region 204 may extend from the first angle to a second angle (e.g., 6-12 angular degrees, etc.) relative to the view direction.

The paracentral region 204 is immediately surrounded by a near-peripheral region 206. The near-peripheral region 206 is immediately adjacent to the mid-peripheral region 208, which in turn is immediately adjacent to the rest of the vision field, a far-peripheral region 210. In some embodiments, the near-peripheral region 206 may extend from the second angle to a third angle (e.g., 25-35 angular degrees, etc.) relative to the view direction. In some embodiments, the mid-peripheral region 208 may extend from the third angle to a fourth angle (e.g., 50-65 angular degrees, etc.) relative to the view direction. The far-peripheral region 210 may extend from the fourth angle to the edge of the vision field.

The first, second, third and fourth angles used in this example logical partition of the vision field may be defined or specified along the transverse direction 212. When the vision field of FIG. 2 corresponds to that at a front level viewing direction, the transverse direction 212 may be the same as, or parallel to, the viewer's interpupil line.

It should be noted that different schemes of logically partitioning a viewer's vision field may be used in addition to, or in place of, the scheme of logically partitioning the viewer's vision field into foveal, paracentral, near-peripheral, mid-peripheral, far-peripheral, etc., regions based on angles as illustrated in FIG. 2.

For example, in some embodiments, the viewer's vision field may be partitioned into more or fewer regions such as a combination of foveal region, a near-peripheral region and a far-peripheral region, etc., without a paracentral region and/or a mid-peripheral region. A spatially faithful representation (or high-fidelity) image portion may be used to cover from the foveal region up to some or all of the near-peripheral region in such logical partition of the viewer's vision field.

In some embodiments, the viewer's vision field may be partitioned based on other quantities other than angles as illustrated in FIG. 2. For example, in a non-limiting implementation, the foveal region may be defined as a vision field region that corresponds a viewer's foveal-vision. The paracentral region may be defined as a vision field region that corresponds to a viewer's retina area where cone/rod densities exceed relatively high cone/rod density thresholds. The near-peripheral region may be defined as a vision field region that corresponds a viewer's retina area where cone/rod densities does not exceed relatively high cone/rod density thresholds respectively but does exceed intermediate cone/rod density thresholds. The mid-peripheral region may be defined as a vision field region that corresponds a viewer's retina area where cone/rod densities does not exceed intermediate cone/rod density thresholds respectively but does exceed relatively low cone/rod density thresholds. A focal-vision region as described herein may cover from the viewer's foveal-vision up to some or all of a region (e.g., some or all of the viewer's near-peripheral vision, etc.) based on threshold(s) (e.g., cone/rod density threshold(s), etc.) that are not necessarily angle-based.

Additionally, optionally or alternatively, a combination of two or more different schemes of logically partitioning the viewer's vision field and/or other human vision factors may be used to determine a focal-vision region of the viewer's vision field. For example, instead of using a focal-vision region as described herein to cover the same angular value range in different angular directions, the focal-vision region as described herein may cover a larger angular value range along the transverse direction 212 than an angular value range covered by the focal-vision region along the vertical direction 214, as the human vision system may be more sensitive to image details along the transverse direction 212 than those along the vertical direction 214.

In some embodiments, a focal-vision region as described herein covers some or all of: a foveal region (e.g., plus a safety margin, etc.), a paracentral region (e.g., excluding and extending from the foveal region, etc.), a near-peripheral region (e.g., further excluding and extending from the paracentral region, etc.), a mid-peripheral region (e.g., further excluding and extending from the near peripheral region, etc.), etc.

Additionally, optionally or alternatively, in some embodiments, a vision field of an eye as described herein takes into consideration vision-related factors such as eye swiveling, viewing constraints from nose, corneal, eyelid, etc.

Examples of a focal-vision region as described herein may include, but are not necessarily limited to, any combination of one or more of: circular shapes, oblong shapes, oval shapes, heart shapes, star shapes, round shapes, square shapes, polygonal shapes, etc.

### Gaze Tracking

In some embodiments, only a (e.g., relatively small) focal-vision region of the eye's vision field needs to be provided with pixel values with the highest dynamic range, the widest color gamut, the highest (or sharpest) spatial resolution, and the like. In some embodiments, the focal-vision region of the eye's vision field may approximately correspond to the entirety of the foveal-vision of the eye up to some or all of near-peripheral vision of the eye. In some embodiments, the focal-vision region of the eye's vision field may additionally include a safety vision field region.

In some embodiments, the size and/or shape of the safety vision field region in the focal-vision region can be preconfigured to a fixed size (e.g., 0%, 5%, 10%, −5%, −10%, etc.) that does not vary with network bandwidth, image content, types of computing devices (e.g., helmet mounted display devices, wall displays, etc.) involved in video applications, types of rendering environments (e.g., cloud-based video streaming servers, etc.) involved in video applications, and the like. In some other embodiments, the size and/or shape of the safety vision field region in the focal-vision region can be dynamically reconfigured at runtime, and can vary in range. For example, in response to determining that network connections do not support a relatively high bandwidth, the size and/or shape of the safety vision field region may be dynamically shrunk at runtime from 10% to 5% over the eye's foveal-vision. On the other hand, in response to determining that network connections support a relatively high bandwidth, the size and/or shape of the safety vision field region may be dynamically expanded at runtime from 5% to 10% over the eye's foveal-vision.

The size and/or shape of the safety vision field region may also be set in dependence on latency in eye tracking. Additionally, optionally or alternatively, eye tracking data as described herein can be used to predict where the viewer would look next and reduce the bandwidth/safety region based on the prediction. For example, the user's view direction at runtime may be tracked by a view direction tracking device. The view direction tracking device may operate in real time with a display on which a sequence of display mapped images is rendered. As the user changes view directions and/or viewing distances from time to time, the view direction tracking device tracks and computes the viewing angles and/or viewing distances in a coordinate system in which the sequence of display mapped images is being rendered, generates a time sequence of view directions, and signals each view direction in the time sequence of view directions to a video streaming server as described herein. Each such signaled view direction of the viewer as received by the video streaming server may be indexed by a time point value. The time point value may be associated or correlated by a video streaming server as described herein with an offset LDSS cube map.

View direction data to track the viewer's view directions is collected while the viewer is viewing a 3D environment or a derivative version. Example view direction data may include, without limitation, linear displacements, angular displacements, linear motions or translations, angular motions or rotations, pitch, roll, yaw, sway, heave, surge, etc., that may be collected by any combination of gaze tracking devices, face tracking devices, FOV tracking devices, and the like. The viewer's view directions at a plurality of time points may be determined. The viewer's view directions can be used on the recipient device itself to generate new views by implementing some or all techniques as described herein on the recipient device (or a device operating in conjunction with the recipient device) until the upstream devices respond with new data.

View direction data may be collected, analyzed, and/or shared/transmitted among view direction tracking devices and streaming devices with relatively low latency (e.g., within a fraction of one image frame time, within 5 milliseconds, etc.). In an example implementation, the view direction tracking data may be shared among these devices using the lowest latency data/network connections where multiple data/network connections are available. The view direction data may be referred to herein as a gaze vector.

In response to determining the viewer's view direction relatively expeditiously with relatively low latency (e.g., within a fraction of an image frame time) based on the view direction data, a video streaming server may dynamically shrink the size and/or shape of the safety vision field region at runtime from 10% to 5% over the eye's foveal-vision. A relatively small area (e.g., within 20 angular degrees from the view direction, etc.) of the highest dynamic range, the widest color gamut, the highest spatial resolution, etc., may be sent in the video signal to the downstream recipient device.

On the other hand, in response to determining the viewer's view direction relatively slowly with relatively high latency (e.g., exceeding a time threshold, more than the fraction of one image frame time, longer than 5 milliseconds, etc.) based on the view direction data, the video streaming server may dynamically expand the size and/or shape of the safety vision field region at runtime from 1% to 3%, 2% to 6%, 5% to 10%, etc., over the eye's foveal vision. A relatively large area (e.g., up to 30 angular degrees from the view direction, etc.) of the highest dynamic range, the widest color gamut, the highest spatial resolution, etc. may be sent in the video signal to the downstream recipient device. That way, the recipient device of the video signal can have sufficient image data over a relatively large focal-vision region to make local decisions based on the view directions for image rendering purposes.

### Cube Mapping Techniques

Embodiments described herein relate to 3D virtual environments generated by a computer graphics engine or captured using one or more cameras. The 3D virtual environment is then accessed using an immersive device, such as a virtual reality headset. To assist with rendering images where resolution is greatest at the center of the viewer's gaze, foveated rendering techniques may be implemented. One technique for representing a 3D environment in one or more 2D textures includes mapping the 3D virtual environment to a cube, thereby generating a cube map. As one example, in a computer graphics program that is operating on the instantaneous state of a 3D model map (e.g., a scene), six virtual cameras are constructed with a common focal point. The six cameras look along the positive and negative directions of three orthogonal axes such that each camera points towards a center of a face of a cube. The common focal point may be situated anywhere within the scene, and the six-camera arrangement may be arbitrarily oriented within the scene.

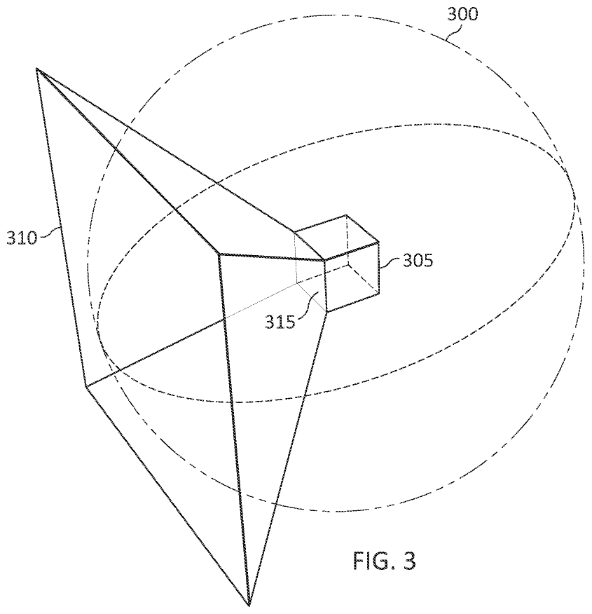

FIG. 3 provides an example cube mapping technique for a 3D environment (e.g., a scene). In the example of FIG. 3, a 3D environment 300 includes a textured cube map 305. A center of the cube map 305 is located at an arbitrary point within of the 3D environment 300. The 3D environment 300 is mapped onto the cube map 305. For example, the cube map 305 includes a first face 315. A camera view 310 (e.g., a virtual camera) is situated at a center of the cube map 305 and faces outwards towards a center of the first face 315 perpendicular to the first face 315. The portion of the 3D environment 300 captured by the camera view 310 is mapped onto the first face 315. This process is repeated for each face of the cube map 305 such that the entire 3D environment 300 is mapped onto the cube map 305.

For the six-camera arrangement example, a virtual cube (e.g., the cube map 305) encloses the six-camera arrangement, with the center of the cube map 305 being coincident with the focal point of the cameras. The focal point of the six cameras may be anywhere within the scene, and is not necessarily located at the center of the scene. The three orthogonal axes pass through the centers of the faces of the cube map 305 (such as the first face 315). Uniform sampling of each face of the virtual cube produces the six images that form the textured cube map 305. Each image is a view of the scene as captured by one of the six cameras. In some instances, the field of view of each camera is 90 degrees.

However, cube mapping may result in spherical samples (or a 3D model map) being more heavily concentrated near the spherical projections of the cube map's edges and corners, and less so at the projections of the cube face centers. This results in higher resolution (in pixels per solid angle) at the corners and edges of the cube and a lower resolution at the center of each face (relative to the edges and corners). Such nonuniformity leads to area and angle distortions in environment maps and artifacts when the cube map is rendered in a viewport. Additionally, when rendering videos, standard cube map sampling wastes rendering time and bandwidth for directions far from the viewer's gaze.

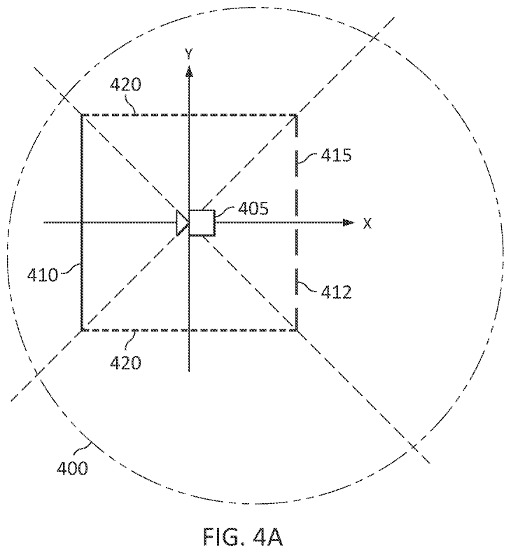

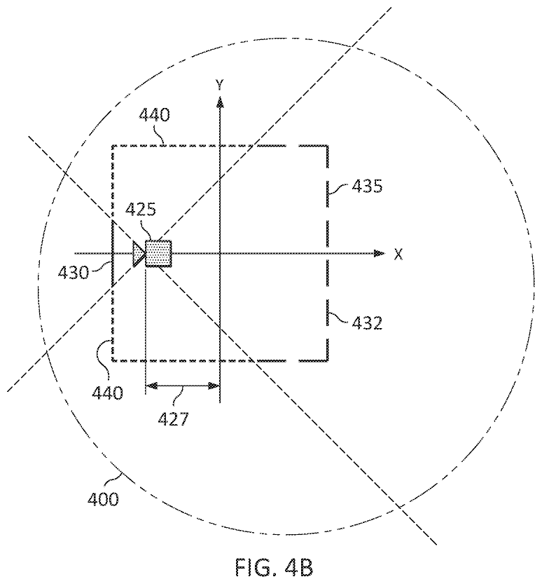

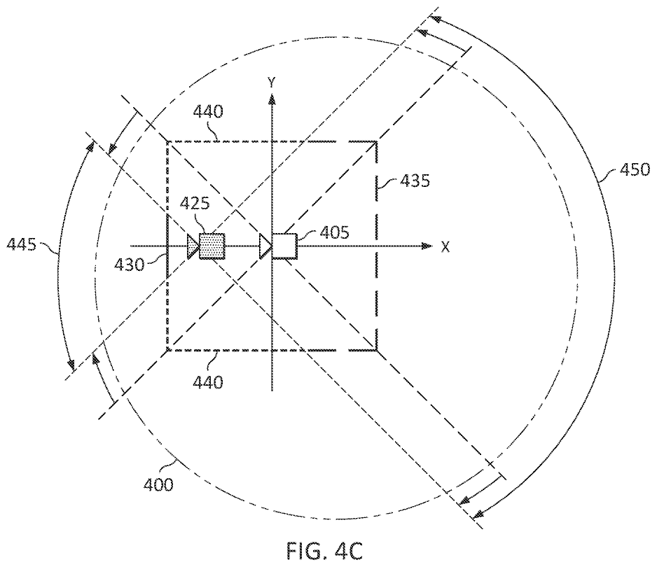

To address such issues, offset cube mapping techniques may be implemented. Offset cube mapping techniques are foveated rendering techniques wherein the virtual cameras used to generate the six faces of a cube map texture are biased, or offset, along one axis. This offset increases detail in the direction of the offset and decreases detail in the opposite direction. For example, FIGS. 4A-4C provides an example offset cube mapping technique for a 3D environment. FIG. 4A illustrates a 3D environment 400 which includes a first virtual camera 405, a textured cube map 412 comprised of six faces, four of which (front face 410, back face 415, and side faces 420) are shown in FIG. 4A. FIG. 4B illustrates a second virtual camera 425 in the 3D environment 400 offset by a bias distance 427 (e.g., an offset bias), and a textured offset cube map 432 comprised of six faces, four of which (front face 430, back face 435, and side faces 440) are shown in FIG. 4B. The bias distance 427 may be a vector having a magnitude and direction away from the common centers of the textured cube map 412 and textured offset cube map 432. A common center of the textured cube map 412 and textured offset cube map 432 is located at a general point within the 3D environment 400. By offsetting the second virtual camera 425, the second virtual camera 425 is closer to an edge of the 3D environment 400 compared to the first virtual camera 405. A first camera view maps a portion of the 3D environment onto the front face 410 of the textured cube map 412, and an offset camera view maps a portion of the 3D environment 400 onto the front face 430 of the textured offset cube map 432.

FIG. 4C illustrates the second virtual camera 425 capturing a narrower view 445 of the environment 400 onto the front face 430 compared to the first virtual camera 405, as depicted by the smaller range of angles subtended by 430 relative to 410, consequently providing a higher level of detail in the front direction. Similarly, the offset back-facing camera (not shown) captures a wider view 450 of the environment 400 onto the back face 435 than the back-facing standard cube map camera (not shown), consequently providing a lower level of detail in that direction.

For the six-camera arrangement example, a virtual cube (e.g., the first textured cube map 405) encloses the six-camera arrangement, as previously described. However, the cube center is offset, along one of the orthogonal axes, from the common camera focal point. Accordingly, the view of the scene of each camera is different, with some cameras having more narrow views and some having wider views of the scene. When each camera samples its corresponding cube face with identical sampling density, cameras with a narrower view of the environment 400 sample the scene with a higher density than cameras with a wider view.

Functionally, the offset cube mapping is performed by applying a cube map texture coordinate transformation applied in a shader before performing a cube map sampling function. By reducing pixels rendered in directions far from the viewer's gaze vector offset cube map, rendering time and required bandwidth are both reduced. However, offset cube mapping may experience a spatial sample warping due to the offset.

### Low Discrepancy Spherical Sampling

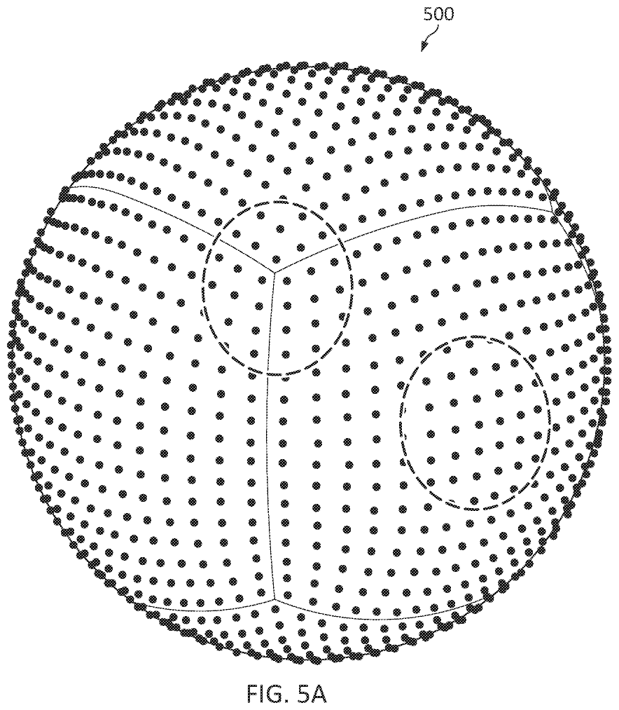

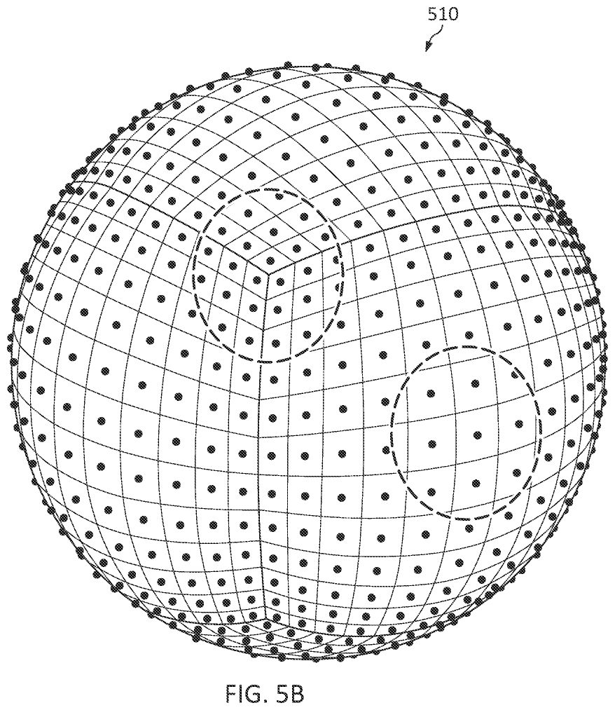

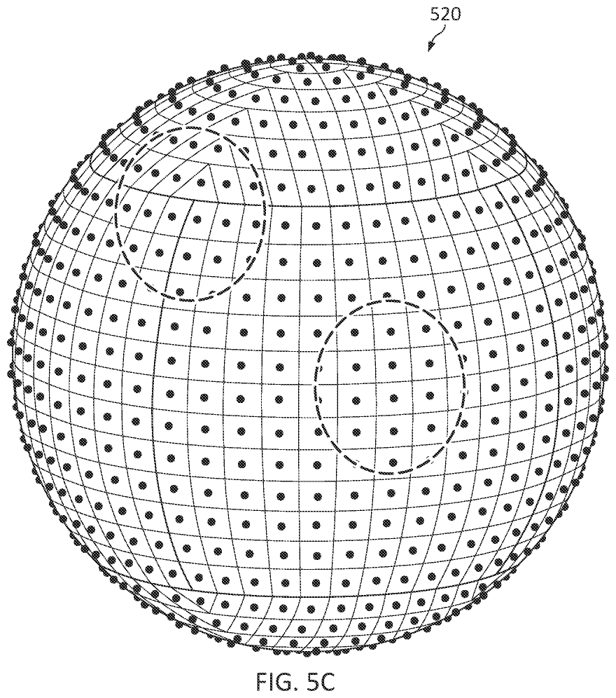

Embodiments described herein provide for the application of the offset cube map's virtual camera bias to a low discrepancy spherical sampling (LDSS). Discrepancy as described herein refers to a measure of the equi-distribution of a pointset on a sphere, where a lower discrepancy value implies a more uniform sampling. Further details on equi-distribution of a pointset on a sphere can be found in “J. Cui, et al., Equidistribution on the Sphere, SIAM Journal on Scientific Computing, 1997, Vol. 18, No. 2: pp. 595-609”, incorporated herein by reference. LDSS techniques described herein exhibit lower discrepancy, area, and angle distortion than standard (e.g., non-offset) cube mapping (such as that shown in FIG. 5).

One example LDSS technique is isocube sampling. Isocube sampling includes first partitioning a spherical surface into four equatorial zones and two polar zones, the area of each equatorial zone and each polar zone being equal. Each zone is then partitioned into a number of N×N elements by a plurality of longitudinal curves and a plurality of latitudinal curves. The resulting N×N elements, when mapped to a cube, are relatively curved (e.g., warped) compared to samples of the standard cube map. Samples on the isocube map are indexed on rings that run parallel to the equator of the sampled sphere. Further detail on isocube sampling can be found in “L. Wan, et al., Isocube Exploiting the Cube map Hardware, IEEE Transactions on Visualization and Computer Graphics, July/August 2007, Vol. 13, No. 4: pp. 720-731”, incorporated herein by reference.

Another example LDSS technique is unicube sampling. Unicube sampling includes partitioning a cube face based on two sets of parallel grid lines. The parallel lines are nonuniformly distributed such that the partition on the projected spherical surface maintains a uniform rectilinear structure. The nonuniform partition of the cube face is then mapped to a uniform partition. Further detail on unicube sampling can be found in “Tze-Yiu Ho, et al., Unicube for Dynamic Environment Mapping, IEEE Transactions on Visualization and Computer Graphics, January 2011, Vol. 17, No. 1: pp. 51-63”, incorporated herein by reference.

LDSS techniques provide improved sampling density uniformity compared to the standard cube mapping of FIG. 3. FIG. 5A illustrates a unicube cube map 500 having unicube sampling density. FIG. 5B illustrates a standard cube map 510 having a non-uniform (e.g., no LDSS technique applied) sampling density. FIG. 5C illustrates an isocube cube map 520 having an isocube sampling density. Sampling of the unicube cube map 500 and the isocube cube map 520 is more uniform compared to the standard cube map 510.

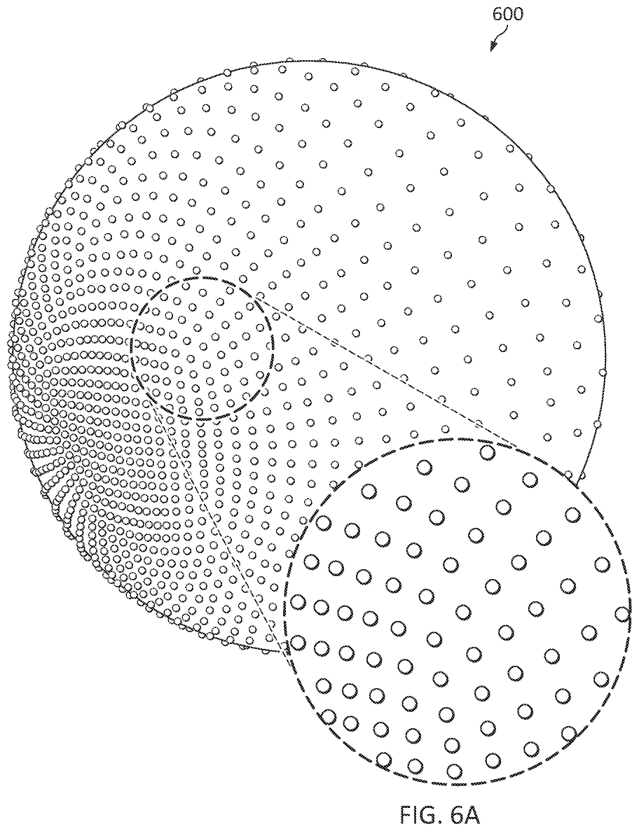

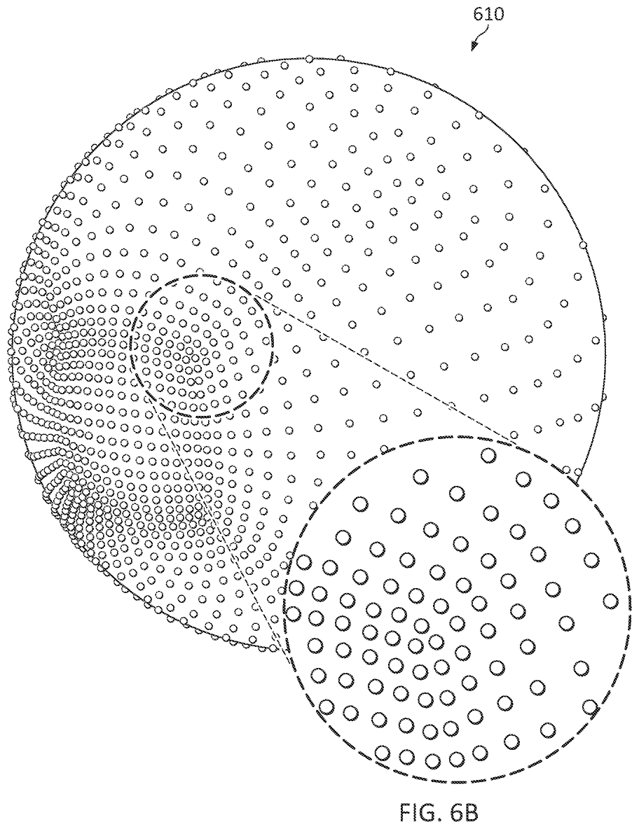

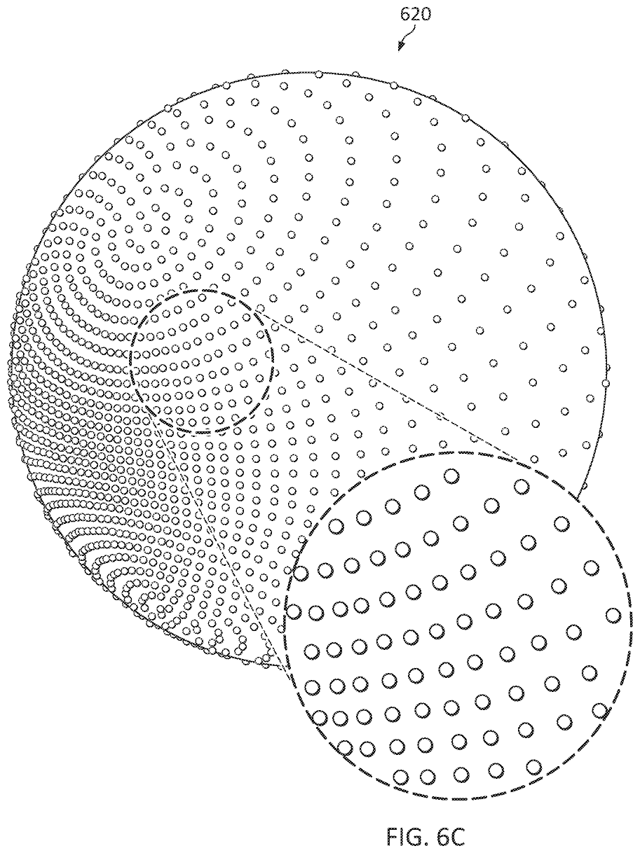

In the same way that LDSS techniques provide improved sample distribution to standard cube map sampling, LDSS techniques also improve the sample distribution of offset cube maps (offset LDSS cube maps). FIG. 6A, for example, illustrates a spherical projection of an offset unicube cube map 600 having both unicube sampling density and offset bias. FIG. 6B illustrates a spherical projection of an offset standard cube map 610 having both standard cube map sampling density and offset bias. FIG. 6C illustrates a spherical projection of an offset isocube cube map 620 having both isocube sampling density and offset bias. Sampling of the offset unicube cube map 600 and the offset isocube cube map 620 is more uniform compared to the offset cube map 610 (ignoring intended spatial warping of the sample coordinates due to offset). Accordingly, implementing both offset bias and LDSS techniques improves the resulting spatial sample distribution relative to using only offset bias. Additionally, implementing both offset bias and LDSS techniques results in better image quality, reduced transmission bandwidth requirements, and (in some instances) better video compression ratios.

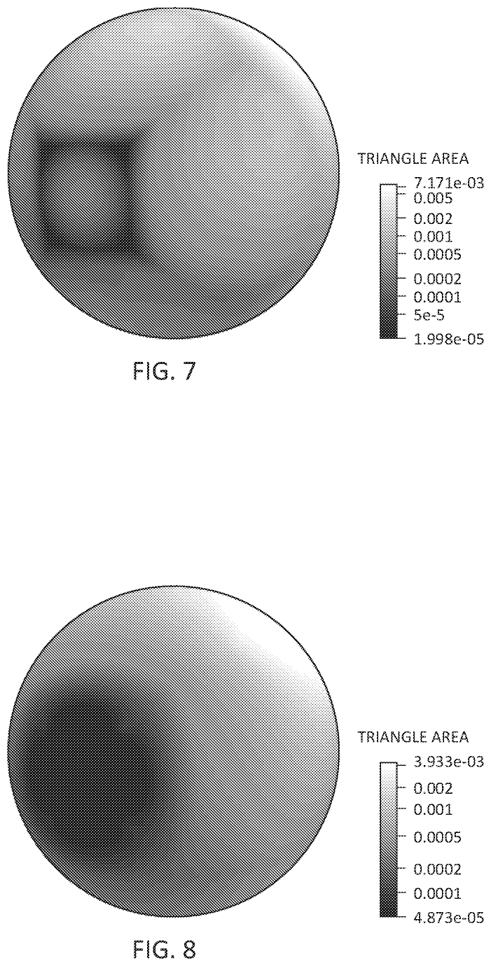

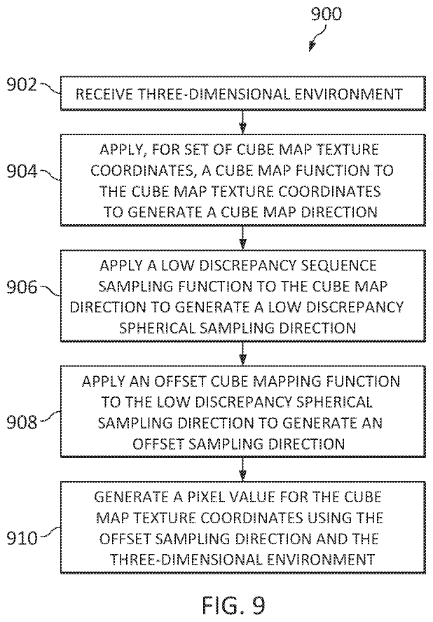

As further examples of the benefits of offset LDSS cube maps, FIG. 7 illustrates the area of triangles from Delaunay triangulation of an offset cube map having no LDSS technique applied. As shown in FIG. 7, triangles having a smaller area (and therefore a higher resolution) are located along the spherical projection regions corresponding to the edges and corners of a face of the cube map. FIG. 8, for comparison, illustrates the area of triangles from Delaunay triangulations of an offset unicube cube map. The triangle areas in FIG. 8 decrease monotonically closer to the center of the offset face compared to FIG. 7.

With reference to the six-camera arrangement example and FIG. 4, before the cube map is offset, the cameras had a less uniform sampling density. After implementing LDSS techniques, the cameras have a more uniform sampling density. Sample positions are changed to provide a more uniform distribution of samples when the sample directions are projected to the surface of a concentric sphere.

Both offset cube mapping and LDSS techniques may be considered to be functions that take input sample directions (represented as either 3D Cartesian coordinates or 2D spherical angles) and produce modified directions as an output. For example, let x=(x, y, z) be a unit length direction vector. A direction vector as used herein refers to a 3-element vector within a 3D environment. A direction vector may be referred to simply as a direction (for example, a unit length direction, a sampling direction, etc.). Equivalent or corresponding spherical angles may be computed from x. Let u=(u, v, f) be cube map texture coordinates, where (u, v) are horizontal and vertical texture coordinates and f is a face index in the range of [1, 6]. Let cm(u)=x with the inverse correspondence being denoted as u=cm⁻¹(x) define a correspondence between direction vectors and standard cube map texture coordinates.

Let d be an axis-aligned offset direction of the form (d, 0, 0), (0, d, 0), or (0, 0, d), where d is a scalar value in the range (−1, 1). Offset cube mapping ocm(x, d) is a function taking a direction vector x and an offset d and returning a modified direction vector xₒ. When applied to a cube map texture coordinate, the modified offset cube mapping sample direction is xₒ(u, d)=ocm(cm(u), d), and the offset cube map pixel at u (i.e., the pixel at location (u, v) on face f) is the environment sample in direction xₒ.

Similarly, low discrepancy sequence sampling is a direction modifying function, where x_{L}=lds(x), with lds( ) representing unicube, isocube, or another LDSS method. Both LDSS and offset direction modifiers may be applied via functional composition to obtain an offset low discrepancy sequence (OLDS) sampling function x_{C}=olds(u, d)=ocm(lds(cm(u), d)), which says that the pixel at u in the OLDS texture, given offset d, is the scene sample in direction ocm(lds(cm(u), d)). By sampling the scene over a discrete set of values of u an OLDS texture map is obtained. This OLDS texture may be encoded and transmitted to a receiver. The offset d is also transmitted to the receiver, or an agreed-upon value by both the sender and the receiver is used.

When the receiver is rendering a scene for display in, for example, an AR or VR headset, the receiver obtains samples of the scene in a plurality of directions. To obtain a scene sample in a direction x* from the received OLDS texture, the OLDS texture coordinate u* is determined by solving Eq. (1) for u*:

$${x}^{*} = olds ( {u}^{*} , d ) = o c m ( l d s ( cm ( {u}^{*} ) , d ) ) \qquad Eq . ( 1 )$$

To solve Eq. (1) for u*, the inverse function of ids( ), ocm( ), and cm( ) are applied, where the inverse functions are denoted with the superscript −1. First, ocm⁻¹( ) is applied to both sides of (1) to undo the offset mapping to produce an LDSS direction:

$$o c {m}^{1} ( {x}^{*} ) = l d s ( cm ( {u}^{*} ) , d )$$

Next, lds⁻¹( ) is applied to both sides to obtain a standard cubemap direction:

$$l d {s}^{1} ( o c {m}^{1} ( {x}^{*} ) , d ) = cm ( {u}^{*} )$$

Last, cm⁻¹( ) is applied to both sides to undo the cube map direction and obtain the cube map texture coordinates u*:

$${cm}^{- 1} ( {lds}^{- 2} ( {ocm}^{- 1} ( {x}^{*} ) , d ) ) = {u}^{*}$$

FIG. 9 illustrates a method 900 for generating pixel values for offset sampling directions. The method 900 may be performed by an electronic processor included in the post-production block 115, an electronic processor included in the image generation block 105, an electronic processor included in the production block 110, and the like. At step 902, the electronic processor receives a 3D environment. The 3D environment may be, for example, a 3D environment map, a 3D game engine scene, a ray-traced environment (e.g., ray tracers), texture-mapped spheres, and other virtual 3D environments capable of being mapped onto a cube map.

At step 904, the electronic processor applies, for a set of cube map texture coordinates, a cube map function to the cube map texture coordinates to generate a cube map direction. For example, for cube map texture coordinates u=(u, v, f), the electronic processor applies cube map function cm( ) to obtain a cube map direction x=cm(u).

At step 906, the electronic processor applies a low discrepancy sequence sampling function to the cube map direction to generate a low discrepancy spherical sampling direction. For example, the electronic processor applies low discrepancy sequence sampling function lds( ) to the cube map direction x to obtain low discrepancy spherical sampling direction x_{L}=lds(x). At step 908, the electronic processor applies an offset cube mapping function to the low discrepancy spherical sampling direction to generate an offset sampling direction. For example, the electronic processor applies offset cube mapping function ocm( ) to the low discrepancy spherical sampling direction x_{L} (given an offset d) to obtain offset sampling direction xₒ=ocm(x_{L}, d).

At step 910, the electronic processor generates a pixel value for the cube map texture coordinates using the offset sampling direction and the 3D environment. For example, applying the cube map function cm( ), the low discrepancy sequence sampling function lds( ), and the offset cube mapping function ocm( ) results in x_{C}=olds(u, d)=ocm(lds(cm(u), d)), which says that the pixel at u in the OLDS texture, given offset d, is the scene sample in direction ocm(lds(cm(u), d)). In some instances, the pixel value and/or the OLDS texture is encoded and transmitted to a receiver.

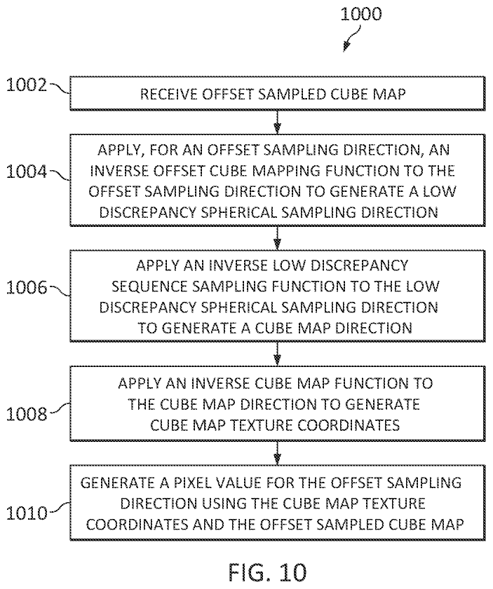

FIG. 10 illustrates a method 1000 for decoding an OLDS texture (e.g., an offset sampled cube map). The method 1000 may be performed by an electronic processor included in the decoding block 130. At step 1002, the electronic processor receives an offset sampled cube map. In some instances, the decoding block 130 decodes a coded bitstream 122 to obtain the offset sampled cube map.

At step 1004, the electronic processor applies, for an offset sampling direction, an inverse offset cube mapping function to the offset sampled cube map to generate a low discrepancy spherical sampling direction. For example, the coded bitstream 122 may include metadata to assist with reconstructing the 3D environment. In some instances, the metadata includes the distance and direction of the bias distance 427 that define ocm⁻¹( ). The electronic processor reverses the distance and direction of the bias distance 427 to undo the bias distance 427 by applying ocm⁻¹( ) to the offset sampling direction x_{C} to obtain x_{L}, as previously described.

At step 1006, the electronic processor applies an inverse low discrepancy sequence sampling function to the low discrepancy spherical sampling direction to generate a cube map direction. For example, the electronic processor applies lds⁻¹( ) to the inverse low discrepancy sequence sampling direction x_{L} to obtain a standard cubemap direction x, as previously described. At step 1008, the electronic processor applies an inverse cube mapping function to the cube map direction to generate cube map texture coordinates. For example, the electronic processor applies cm⁻¹( ) to the cube map direction x to obtain cube map texture coordinates u. At step 1010, the electronic processor generates a pixel value for the offset sampling direction using the cube map texture coordinates and the offset sampled cube map.

For interactive content such as VR and AR, the bias vector (d) (e.g., the magnitude and/or the direction) may be dynamically aligned with the gaze vector of the viewer's viewing direction to maximize rendered image quality. Additionally, the magnitude of the bias vector may be varied based on a rate of change of the gaze vector. For example, when the viewing direction is moving quickly, the magnitude of the bias vector may be reduced such that visual quality is more consistent across quickly-changing viewing angles. In one example of fast-moving viewing direction, virtual cameras used to render a head-mounted display's left and right eye images are quickly changing their orientation in response to rapidly-changing user events such as head turns, controller manipulations, and gaze direction changes. In some implementations, the magnitude of the bias vector (e.g., the amount of offset) is determined based on a linear function. In other implementations, the magnitude of the bias vector is increased as the rate of change of the gaze vector increases beyond thresholds. For example, when the rate of change is below a first threshold, a first bias vector magnitude is selected. When the rate of change is above the first threshold but less than a second threshold, a second bias vector magnitude is selected. When the rate of change is above the second threshold, a third bias vector magnitude is selected.

Additionally, for linear cinematic 360° content, the magnitude of the bias vector may be varied based on the likelihood that a viewer will be looking in a particular direction, or on the importance of action at a particular orientation. For example, for video content including a story line, it is highly likely that viewers will be looking in the specific direction of the story. The axis of offset (e.g., the direction of the bias vector) may be aligned with those directions, and increasing the magnitude of the bias vector in that direction increases visual quality for important regions.

While embodiments described herein have primarily referred to a full 360° environment, in some instances, less than the full 360° environment is rendered. For example, a subset of the six cube faces (for example, five faces) may be rendered. As another example, subregions within the faces may be rendered.

The above video delivery systems and methods may provide for image processing and 360° image rendering. Systems, methods, and devices in accordance with the present disclosure may take any one or more of the following configurations.
(1) An image processing system for encoding spherically-sampled data, the image processing system comprising: a processor to perform encoding of data, the processor configured to: receive a three-dimensional environment; apply, for a set of cube map texture coordinates, a cube map function to the cube map texture coordinates to generate a cube map direction; apply a low discrepancy sequence sampling function to the cube map direction to generate a low discrepancy spherical sampling direction; apply an offset cube mapping function to the low discrepancy spherical sampling direction to generate an offset sampling direction; and generate a pixel value for the cube map texture coordinates using the offset sampling direction and the three-dimensional environment.
(2) The image processing system according to (1), wherein the low discrepancy spherical sampling operation is a unicube sampling operation.
(3) The image processing system according to (1), wherein the low discrepancy spherical sampling operation is an isocube sampling operation.
(4) The image processing system according to any one of (1) to (3), wherein the processor is further configured to: provide the pixel value for the cube map texture coordinates via a virtual reality device.
(5) The image processing system according to any one of (1) to (4), wherein the processor is configured to apply the offset cube mapping function by performing operations comprising: receiving a gaze vector indicative of a viewing direction of a user; determining a rate of change of the gaze vector; and selecting an offset value based on the rate of change of the gaze vector.
(6) The image processing system according to (5), wherein selecting the offset value includes: selecting a first offset value when the rate of change of the gaze vector is less than a first threshold; and selecting a second offset value when the rate of change of the gaze vector is greater than or equal to the first threshold, wherein the first offset value is greater than the second offset value.
(7) The image processing system according to any one of (1) to (6), wherein the processor is further configured to: receive a gaze vector indicative of a viewing direction of a user; and align the offset sampling direction with the gaze vector.
(8) The image processing system according to any one of (1) to (7), wherein the processor is further configured to: select a sampling frequency of the low discrepancy sequence sampling function.
(9) The image processing system according to any one of (1) to (8), wherein the processor is configured to apply the cube map function to the cube map texture coordinates in a shader.
(10) An image processing system for encoding spherically-sampled data, the image processing system comprising: a processor to perform encoding of data, the processor configured to: receive a three-dimensional environment; apply, to a set of cube map texture coordinates, an offset low discrepancy sequence (OLDS) sampling function to generate an OLDS direction; and generate a pixel value for the cube map texture coordinates using the OLDS direction and the three-dimensional environment.
(11) The image processing system according to (10), wherein the OLDS sampling function includes a unicube sampling function.
(12) The image processing system according to (10), wherein the OLDS sampling function includes an isocube uniform sampling function.
(13) The image processing system according to any one of (10) to (12), wherein the processor is apply the OLDS sampling function by performing operations comprising: receiving a gaze vector indicative of a viewing direction of a user; determining a rate of change of the gaze vector; selecting an offset value based on the rate of change of the gaze vector; and applying an offset cube mapping function using the offset value.
(14) The image processing system according to (13), wherein selecting the offset value includes: selecting a first offset value when the rate of change of the gaze vector is less than a first threshold; and selecting a second offset value when the rate of change of the gaze vector is greater than or equal to the first threshold, wherein the first offset value is greater than the second offset value.
(15) The image processing system according to any one of (10) to (14), wherein the processor is further configured to: receive a gaze vector indicative of a viewing direction of a user; and align an offset sampling direction of the OLDS sampling function with the gaze vector.
(16) The image processing system according to any one of (10) to (15), wherein the processor is further configured to: select a sampling frequency of the OLDS sampling function.
(17) An image processing system for decoding spherically-sampled data, the image processing system comprising: a processor to perform decoding of data, the processor configured to: receive, from a coded bitstream, an offset sampled cube map; apply, for an offset sampling direction, an inverse offset cube mapping function to the offset sampling direction to generate a low discrepancy spherical sampling direction; apply an inverse low discrepancy sequence sampling function to the low discrepancy spherical sampling direction to generate a cube map direction; apply an inverse cube map function to the cube map direction to generate cube map texture coordinates; and generate a pixel value for the offset sampling direction using the cube map texture coordinates and the offset sampled cube map.
(18) The image processing system according to (17), wherein the inverse low discrepancy sequence sampling function is an inverse unicube sampling function.
(19) The image processing system according to (17), wherein the inverse low discrepancy sequence sampling function is an inverse isocube sampling function.
(20) The image processing system according to any one of (17) to (19), wherein the processor is further configured to: receive, from the coded bitstream, metadata associated with the offset sampled cube map, wherein the metadata includes the inverse offset cube mapping function.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in fewer than all features of a single disclosed embodiment. Thus, the following claims are hereby incorporated into the Detailed Description, with each claim standing on its own as a separately claimed subject matter.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Some embodiments may be implemented as circuit-based processes, including possible implementation on a single integrated circuit.

Some embodiments can be embodied in the form of methods and apparatuses for practicing those methods. Some embodiments can also be embodied in the form of program code recorded in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the patented invention(s). Some embodiments can also be embodied in the form of program code, for example, stored in a non-transitory machine-readable storage medium including being loaded into and/or executed by a machine, wherein, when the program code is loaded into and executed by a machine, such as a computer or a processor, the machine becomes an apparatus for practicing the patented invention(s). When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term compatible means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

“BRIEF SUMMARY OF SOME SPECIFIC EMBODIMENTS” in this specification is intended to introduce some example embodiments, with additional embodiments being described in “DETAILED DESCRIPTION” and/or in reference to one or more drawings. “BRIEF SUMMARY OF SOME SPECIFIC EMBODIMENTS” is not intended to identify essential elements or features of the claimed subject matter, nor is it intended to limit the scope of the claimed subject matter.

1. An image processing system for encoding spherically-sampled data, the image processing system comprising:
a processor to perform encoding of data, the processor configured to:
receive a three-dimensional environment;
apply, for a set of cube map texture coordinates, a cube map function to the cube map texture coordinates to generate a cube map direction;
apply a low discrepancy sequence sampling function to the cube map direction to generate a low discrepancy spherical sampling direction;
apply an offset cube mapping function to the low discrepancy spherical sampling direction to generate an offset sampling direction; and
generate a pixel value for the cube map texture coordinates using the offset sampling direction and the three-dimensional environment.

2. The image processing system according to claim 1, wherein the low discrepancy sequence sampling function is a unicube sampling function.

3. The image processing system according to claim 1, wherein the low discrepancy sequence sampling function is an isocube uniform sampling function.

4. The image processing system according to claim 1, wherein the processor is further configured to: provide the pixel value for the cube map texture coordinates via a virtual reality device.

5. The image processing system according to claim 1, wherein the processor is configured to apply the offset cube mapping function by performing operations comprising:
receiving a gaze vector indicative of a viewing direction of a user;
determining a rate of change of the gaze vector; and
selecting an offset value based on the rate of change of the gaze vector.

6. The image processing system according to claim 5, wherein selecting the offset value includes:
selecting a first offset value when the rate of change of the gaze vector is less than a first threshold; and
selecting a second offset value when the rate of change of the gaze vector is greater than or equal to the first threshold, wherein the first offset value is greater than the second offset value.

7. The image processing system according to claim 1, wherein the processor is further configured to:
receive a gaze vector indicative of a viewing direction of a user; and
align the offset sampling direction with the gaze vector.

8. The image processing system according to claim 1, wherein the processor is further configured to: select a sampling frequency of the low discrepancy sequence sampling function.

9. The image processing system according to claim 1, wherein the processor is configured to apply the cube map function to the cube map texture coordinates in a shader.

10. An image processing system for encoding spherically-sampled data, the image processing system comprising:
a processor to perform encoding of data, the processor configured to:
receive a three-dimensional environment;
apply, to a set of cube map texture coordinates, an offset low discrepancy sequence (OLDS) sampling function to generate an OLDS direction; and
generate a pixel value for the cube map texture coordinates using the OLDS direction and the three-dimensional environment.

11. The image processing system according to claim 10, wherein the OLDS sampling function includes a unicube sampling function.

12. The image processing system according to claim 10, wherein the OLDS sampling function includes an isocube uniform sampling function.

13. The image processing system according to claim 10, wherein the processor is configured to apply the OLDS sampling function by performing operations comprising:
receiving a gaze vector indicative of a viewing direction of a user;
determining a rate of change of the gaze vector;
selecting an offset value based on the rate of change of the gaze vector; and
applying an offset cube mapping function using the offset value.

14. The image processing system according to claim 13, wherein selecting the offset value includes:
selecting a first offset value when the rate of change of the gaze vector is less than a first threshold; and
selecting a second offset value when the rate of change of the gaze vector is greater than or equal to the first threshold, wherein the first offset value is greater than the second offset value.

15. The image processing system according to claim 10, wherein the processor is further configured to:
receive a gaze vector indicative of a viewing direction of a user; and
align an offset sampling direction of the OLDS sampling function with the gaze vector.

16. The image processing system according to claim 10, wherein the processor is further configured to:
select a sampling frequency of the OLDS sampling function.

17. An image processing system for decoding spherically-sampled data, the image processing system comprising:
a processor to perform decoding of data, the processor configured to:
receive, from a coded bitstream, an offset sampled cube map;
apply, for an offset sampling direction, an inverse offset cube mapping function to the offset sampling direction to generate a low discrepancy spherical sampling direction;
apply an inverse low discrepancy sequence sampling function to the low discrepancy spherical sampling direction to generate a cube map direction;
apply an inverse cube map function to the cube map direction to generate cube map texture coordinates; and
generate a pixel value for the offset sampling direction using the cube map texture coordinates and the offset sampled cube map.

18. The image processing system according to claim 17, wherein the inverse low discrepancy sequence sampling function is an inverse unicube sampling function.

19. The image processing system according to claim 17, wherein the inverse low discrepancy sequence sampling function is an inverse isocube sampling function.

20. The image processing system according to claim 17, wherein the processor is further configured to:
receive, from the coded bitstream, metadata associated with the offset sampled cube map, wherein the metadata includes the inverse offset cube mapping function.
